(19) United States
(12) Patent Application Publication
(10) Pub. No.: US 2009/0093952 A1
(43) Pub. Date: Apr. 9, 2009

(54) National Radio Network for Ground Vehicle Traffic Management

(76) Inventor: James C. Lassiter, SR., (US)

Correspondence Address: JAMES C. LASSITER SR., 4705 THORNTREE DR., PLANO, TX, 75024, US

(21) Appl. No.: 11/866,953

(22) Filed: Oct. 3, 2007

(51) Int. Cl. G06F 19/00

(52) U.S. Cl. 701/117; 340/905

(57) ABSTRACT

A “Traffic Reporting” Method and System utilizing a unique traffic data gathering and processing methodology consisting of both personal testimony and available commercial computer related traffic program data. Analysis of the gathered data is then achieved resulting in timely and accurate critical traffic related information and/or route evasion instructional information which shall be broadcast for public consumption on a continuous “Real-time” bases via FM-VHF radio broadcast utilizing a Localized National Network of Radio Broadcast Stations (RBS). The RBS shall be engineered in a Cellular Zone type areas or Radio Broadcast Zones (RBZ) which shall provide coverage to each assigned metropolitan area.

### TECHNICAL FIELD

A “Traffic Reporting” Method and System utilizing a unique traffic data gathering and processing methodology consisting of both personal testimony and available commercial computer related traffic program data. Analysis of the gathered data are then achieved resulting in timely and accurate critical traffic related information and/or route evasion instructional information which shall be broadcast for public consumption on a continuous “Real-time” bases via FM-VHF radio broadcast utilizing a Localized National Network of Radio Broadcast Stations (RBS). The RBS shall be engineered in a Cellular Zone type areas or Radio Broadcast Zones (RBZ) which shall provide coverage to each assigned metropolitan area.

### BACKGROUND TO THE INVENTION

1. Field of the Invention

The present invention relates to the utilization of a National Network of FM-VHF (30 MHz-300 MHz) radio stations solely dedicated to providing real-time, continuous (24×7×365) broadcasts of vehicular ground traffic related information and/or instructional routing data for the general public at no charge, requiring no subscriber fees and/or no special receiver type equipment.

2. Description of Related Art

Currently there are numerous methods of collecting and disseminating data associated with local vehicular ground traffic conditions, both machine (technological) oriented and via human intervention. There are currently numerous independent radio broadcasts of (I.) Public and (II.) Private charter. These independently compose and deliver various levels of traffic related data; however each has its own deficiencies:
I. Public (AM/FM Radio) broadcast traffic updates are not considered in “real-time” when it comes to the segment of “Traffic status delivery” and has a tendency to be highly inaccurate and of a broadcast frequency that which is considered unreliable and inconsistent.
II. Private (e.g. XM, SIRIUS) broadcasters charge a monthly subscriber fee and require special high priced receiver type equipment and costly installation. Coverage is not readily available on a nation wide bases, nor affordable to the majority of the general public.

This particular invention proposes to combine both a Process and Associated System (radio network) which will provide Timely, Accurate and Free of charge, Real-time, Continuous (24×7×365) motor vehicle traffic related information, which requires no special radio receiving hardware or software to be acquired.

Any standard Public FM band radio may receive these broadcasts. Simply a totally free service for the masses which will save time, money, lives, cut air pollution, the United States dependency on fossil fuel and would be a great asset to the U.S. National Defense and FEMA (Federal Emergency Management Agency) for the dissemination of emergency information for evacuation purposes.

### SUMMARY OF THE INVENTION

The “National Ground Transportation Radio Network” (NGTRN) consist of a National Network of Public FM-VHF (Frequency Modulated-Very High Frequency, 30 MHz-300 MHz) Radio Broadcast Stations (RBS). These RBS shall be engineered (*) or arranged in a “Cellular Type” Network Architecture which shall cover via Radio Broadcast, each City (or group there of) for all given States within the so called “United States of America” which shall provide Traffic related information to the General Public.
*Actual engineering of each metropolitan area (City or Group there of), its associated Radio Broadcast Zones (RBZ) and subsequent cellular type coverage requiring receipt of the proposed public FM-VHF radio broadcast signal via the NGTRN may vary, based upon the United States—Federal Communication Commission's (FCC) ability to obtain and assign actual channels which would most likely be, but not limited to the radio frequency spectrum of 30 MHz-300 MHz. Re-arrangement of said existing radio frequency(s) or channels is probable but not absolute. As well, the radio frequency assignments and associated engineering of terrestrial antenna placement and/or height and transmit power may also be limited to and factored upon the actual surrounding physical terrain (i.e. mountain) which may have a limited affect upon the performance (transmission) and/or receipt of said FM-VHF radio broadcasts which shall factor into said engineering for RBZ coverage.

The Coverage Area(s) which the Radio Broadcast shall transmit to, or reach, may also be referred to as the “Radio Broadcast Zone” (RBZ). These RBZ shall be solely dedicated to the Continuous, Real-Time, Reporting of Vehicular Ground Traffic related information and/or shall focus on Critical Traffic situations which may have a Negative affect upon the Timely, Safe and Efficient Movement of any or all Vehicle Ground Traffic which utilizes the Public Roadways, Toll Roads, Intra-state and/or Inter-state Highway System in or within any Geographic or Metropolitan region (i.e. City, State or area) within the so called United States of America (USA).

Receipt of said ‘Broadcast Service’ shall require no special acquisition or purchase of any specific radio receiver type equipment and/or software and shall be easily accessible and available free of any charges to the General Public 24 hours per day, 7 days a week and 365 days per year. NGTRN broadcasts shall be easily accessible via any Standard “Public” FM-VHF band Radio Receiver via proposed public FM Band channel(s). Secondarily this data (the Broadcast) may also be obtained by (but not limited to) Cellular/Landline Telephone via toll-free numbers, Personal Computer access or/or similar device.

### BRIEF DESCRIPTION OF THE DRAWINGS

FIG. 1 Represents a “Consolidated” high level view of a typical “Radio Broadcast Station” (RBS) and the associated high level process flow of Gathering, Analyzing and Dissemination of the related vehicular ground traffic information.

FIG. 2 Represents a “Sectional” high level view of a “National Ground Transportation Radio Network” (NGTRN) depicting the proposed “Cellular” type coverage (a.k.a. Radio Broadcast Zones—RBZ) as they maybe engineered to efficiently cover a segment of the over all proposed North American—United States.

FIG. 3.x Represents the process of which a Vehicle may travel in, out and/or return to, and receive or lose the RBZ coverage in relation to a Radio Broadcast Station (RBS).

### DETAILED DESCRIPTION OF THE PREFERRED EMBODIMENT

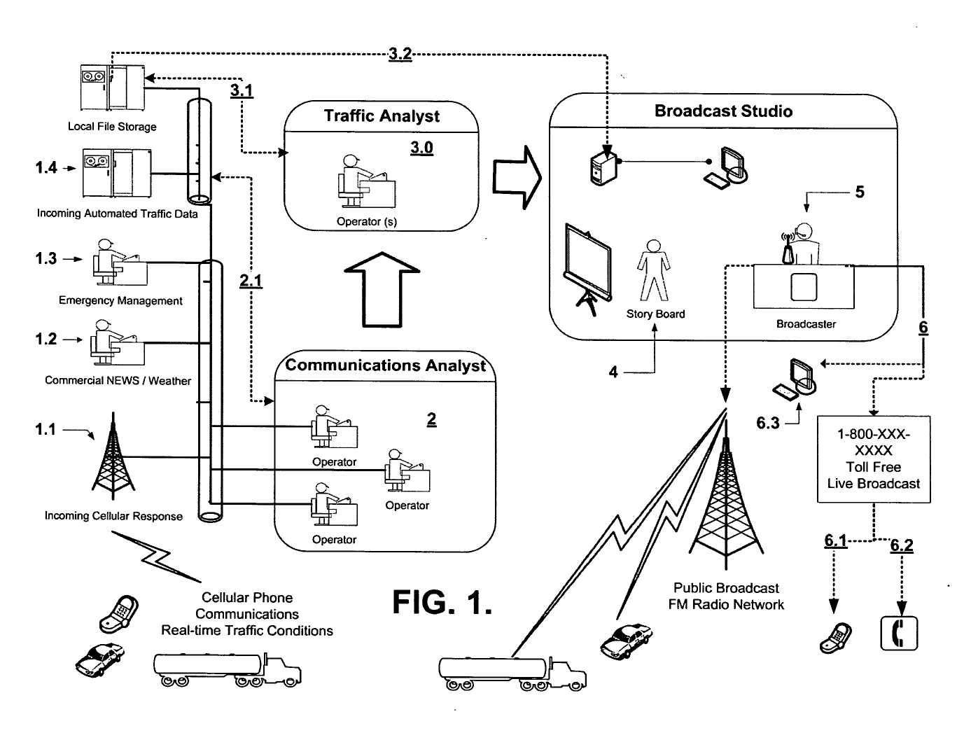

FIG. 1—All up to the minute real-time traffic “Observations” and traffic related “Machine type data” shall be reported, received and documented via several independent sources, some more reliable and timely than others, these are listed below;
(1.1). On Site Eye-witness Motorists (usually the General Public) equipped with personal “hands free” cell phones (or like equipment) would voluntarily dial special “toll free” numbers provided by Licensed Cellular Service Operators and/or Telecom Service Providers to gain access to a Radio Broadcast Station (RBS).
(1.2). Direct Established Communication links with Federal, State and/or Private NEWS/Weather Representatives and/or points of contact who shall provide vital traffic affecting data that may contribute to and/or resolve traffic congestion either in a proactive or reactive manner.
(1.3). Direct Established Communications links with Federal, State and/or Local Emergency Response team status (e.g. FEMA, Police, Sheriff, Fire, EMT ground and/or air services . . . etc.). (May also include cellular phone calls).
(1.4). Federal, State, Local and/or Private Automated and/or Computerized “Machine Type Data” which would provide accurate and timely traffic and/or weather condition related information.
(2) All Pertinent “Public Initiated” Traffic Affecting Status Information (Observation data) shall be forwarded to and received, consolidated and verified at the NGTRN Station by a human contact or “Communications Analyst”.
   (2.1). Documentation of the “Observation Data” would then be analyzed, summarized and inputted via common computer keystroke into a relational on site data base (i.e. Local File-Server type Storage/access).
(3) Upon completion of (2) above, a “Traffic Analyst” would then examine and further analyze “all inputted information” reconciling the accuracy of each situation, then begin “Scripting” the suggested Alternate Routes, Warnings, Evacuation Proceedings and/or Instructions required to insure traffic flows smoothly, efficiently and safely.
   (3.1). These consolidated recommendations would be inputted via computer keystroke into the same relational on site data base for the “Broadcast Desk” to eventually view and share.
   (3.2). From the relational data base the “Refined” Traffic Data is then forwarded to the Broadcast Studio for further processing and Actual Broadcasting.
(4) A large physical graphic “Story Board” with Traffic Symbols and Indicators depicting the “Areas of Concern” on a geographic map depicting the Actual Real-time conditions via a consolidated regional view.
(5) From there the “Broadcaster's desk” would combine the Text (Traffic Data) received, view the “Story Board” and Broadcast the real-time recommendations to the “General Public” over the airwaves.
(6) Real-time access of any NGTRN FM Radio broadcast shall also be accessed via the following (but not limited to).
   (6.1). Cellular network phone or similar devise connected to a cellular network
   (6.2). Land Line (by dialing certain toll free 1-800 numbers)
   (6.3). Personal Computer/Web Site—Utilizing Internet Type Access

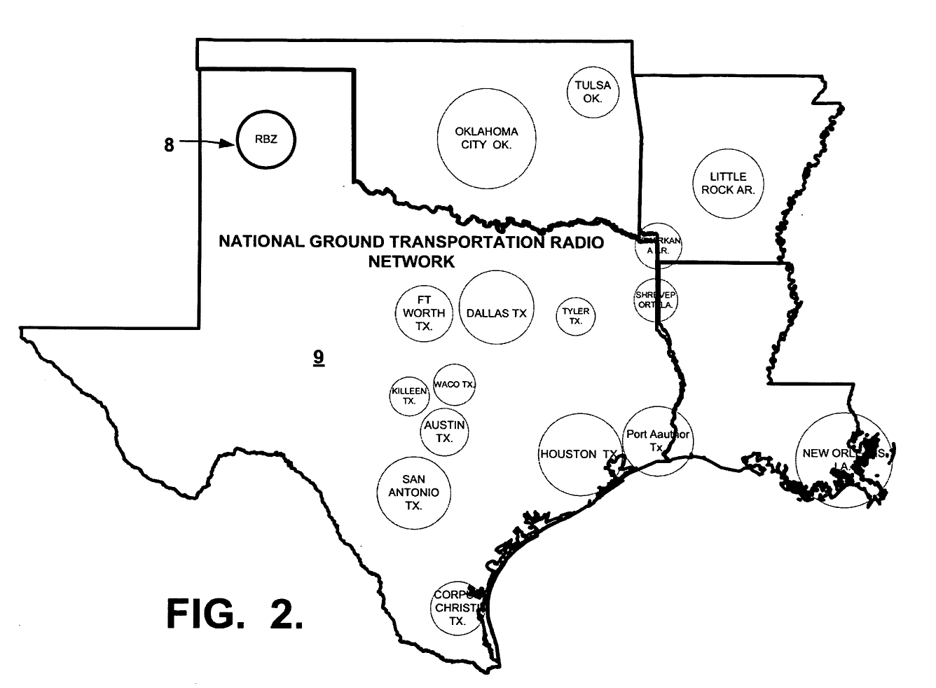

FIG. 2—A conceptual drawing of a geographical section of the Southwestern United States which shall be utilized as an example for illustration purposes depicting a National Ground Transportation Radio Network (in part). The “National Network” as a whole, shall encompass potentially the complete geographic regions of the United States of America.

Any particular Metropolitan area (or group there on with a human populous of a preconceived statistical level may qualify for NGTRN coverage and its associated Traffic Broadcast Services. This coverage consisting of one or more “Radio Broadcast Zones” (RBZs) or “Cells” (8) would provide Radio Broadcast Service as described within this document for the reception of all Ground Vehicular Traffic.

Several of these Radio Broadcast Zones (RBZ's) or “Cells” strategically dispersed through out the United States would then makeup a “National” Ground Transportation Radio Network (NGTRN) as a whole (9).

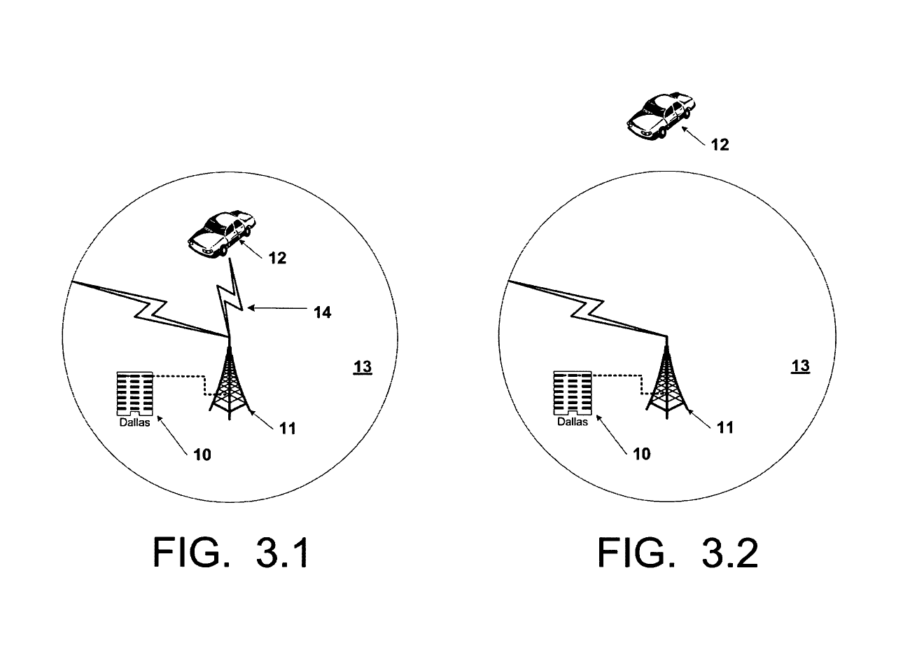

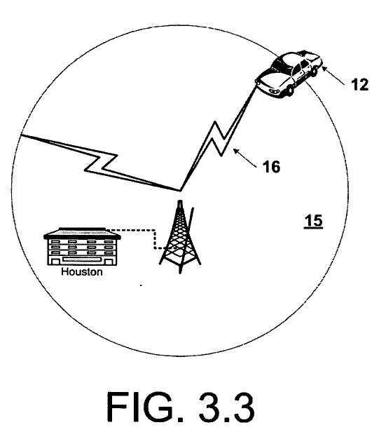

FIG. 3.1—Mode of operation; A Radio Broadcast Station—RBS (10) would transmit FM-VHF (30 MHz-300 MHz) public band radio broadcasts via constructed traditional terrestrial antenna (11).

A vehicle (12) traveling within one specific geographic area or RBZ (13) would be able to automatically receive the most available radio broadcast signal or channel (14) simply based upon the engineering of the radio station antenna location, construction height and transmission power of the broadcast signal (channel) itself, which may be received via any standard FM-VHF radio receiver (in this and most cases located within a vehicle).

If the vehicle travel does not leave or enter out of its existing RBZ, then the existing receipt of the present radio broadcast for that specific geographic region or metropolitan area would not change and remain constant.

FIG. 3.2—If the vehicle (12) travels away from and leaves its present RBZ (13), the existing radio broadcast signal or channel will eventually weaken to an extent that it will lose the broadcast reception.

FIG. 3.3—Eventually the vehicle (12) will either return to its original RBZ or venture into another new RBZ (15) by which the vehicles FM radio receiver will pick up the new stronger signal or channel (16) and home into it for existing traffic broadcast reception for that particular metropolitan area or RBZ.

I claim:

1. A Method for facilitating the Gathering and Analyzation of vehicular ground traffic related information comprising
I. of Manual related teleconferencing and
II. The subsequent receipt of Automated Machine Type (i.e. computer related) data. The combining of and subsequent analyzation of either/both shall result in accurate, timely and informative traffic broadcast information.

2. In accordance with claim 1, (I.) methodology which shall involve data gathering sources which require human intervention via cellular telephone, text messaging (or like devices) which shall provide site specific traffic related data regarding certain geographic location(s) that shall contribute to and/or resolve traffic congestion either in a proactive or reactive manner.

3. In accordance with claim 1, (I.) methodology which shall involve communication with Federal, State and/or Private NEWS/Weather Representatives and/or points of contact who shall provide vital traffic affecting data that may contribute to and/or resolve traffic congestion either in a proactive or reactive manner.

4. In accordance with claim 1, (I.) a methodology which shall involve Emergency Management Personnel (Federal, State and/or Private), either in the field or central office location which shall provide critical traffic related data that may contribute to and/or resolve traffic congestion either in a proactive or reactive manner.

5. In accordance with claim 1, (II.) a methodology which shall result within the collection and aggregate of computerized data from which shall be sourced from Federal, State, and/or Private entity that may contribute to and/or resolve traffic congestion either in a proactive or reactive manner.

6. A System(s) for the facilitation of Delivery of Traffic related information
enabling continuous “real-time” traffic radio broadcast to Public sector travelers and/or Private ground vehicle transportation traveling within and/or through any certain select metropolitan area(s) on a national bases.

7. Where as claim 6 shall be comprised of a “National Network” of Public FM-VHF (30 MHz-300 MHz) band radio stations engineered in a “Cellular Type” coverage, providing Real-time, Continuous Public Radio Broadcasting of critical vehicular ground related traffic affecting conditions and/or instructional data.

8. In accordance with claim 7, National Network shall refer to but not necessarily be limited to the continental United States, Alaska and Hawaii.

9. In accordance with claim 7, Cellular Type shall be synonymous to a “Radio Broadcast Zone” which shall refer to a geographical region or area of population which shall receive the radio broadcast Traffic related data.

10. In accordance with claim 7, the radio broadcast signal shall be Continuous or “Uninterrupted”, better known as; 24 hours per day, 7 days per week, 365 days per year (24×7×365).
